(19) United States
(12) Patent Application Publication
(10) Pub. No.: US 2011/0308356 A1
(43) Pub. Date: Dec. 22, 2011

(54) METHOD FOR SORPTION RECOVERY OF PRECIOUS METALS

(76) Inventors: Izabella Alekseevna Logvinenko, Moscow (RU); Tatyana Veniaminovna Vlasova, Moscow (RU); Andrei Filippovich Smetannikov, Perm (RU); Arkadiy Evgenievich Krasnoshtein, Perm (RU); Tatyana Froyanovna Weitzman, Perm (RU)

(21) Appl. No.: 13/138,002

(22) PCT Filed: Sep. 8, 2009
(86) PCT No.: PCT/RU2009/000457

§ 371 Date: Jun. 22, 2011

(30) Foreign Application Priority Data
Jan. 11, 2009 (RU) 2009100432

(51) Int. Cl. C22B 11/00

(52) U.S. Cl. 75/741

(57) ABSTRACT

The method for sorptive extraction of precious metals from mineral raw materials containing alkaline and alkaline earth metal chlorides relates to hydrometallurgy and can be used for extracting precious metals (palladium, platinum, gold and silver) from different types of raw mineral materials. It includes sorption of precious metals from a pulp using a synthetic sorbent that contains strong and weak base functional groups, followed by desorption. Sorbent is washed in two stages with the liquid phase of the waste pulp and water, and then precious metals are desorbed using a hydrochloric acid solution of thiourea. Precious metals are precipitated from the thiourea solution into a collective concentrate using an ammonium hydroxide solution. The process is carried out in a cascade of six devices with screen drainages with a fixed volume of sorbent load in each device. Precious metals are desorbed at 50-60° C. using a solution containing thiourea and hydrochloric acid.

### CROSS-REFERENCE TO RELATED APPLICATIONS

This application is a U.S. national phase application of a PCT application PCT/RU2009/000457 filed on 8 Sep. 2009, published as WO2010/080050, whose disclosure is incorporated herein in its entirety by reference, which PCT application claims priority of a Russian Federation patent application RU2009/100432 filed on 11 Jan. 2009.

### FIELD OF THE INVENTION

This invention relates to hydrometallurgy and can be used for recovery of precious metals (palladium, platinum, gold and silver) from different kinds of minerals.

### BACKGROUND OF THE INVENTION

In the related art there is known a method for sorption recovery of palladium from chloride solutions in the presence of large amounts of copper (more than 100 g/dm³) (Tzvetnye Metally (Non-Ferrous Metals), 2004, # 3, pp. 30-33) that involves recovery of palladium with Rossion-5 anion-exchange resin (anionite), and its desorption with a concentrated hydrochloric acid. The method has certain disadvantages, such as difficulties in the recovery of palladium from hydrochloric acid and a high consumption of reactants (reagents).

Another related art hydrometallurgical method for recovery of platinum group metals from ores, concentrates, and intermediate products (Khimicheskaya Tekhnologia-Chemical Technology), # 12, 2003, pp. 34-38 and 48) involves an oxidizing roasting and chlorine leaching of ore material in severe conditions (high concentration of leaching reagent) with recovery of 98-99% of platinum metals into hydrochloric acid solutions, and their sorption with strongly basic anion-exchange resins (anionites) and burning of saturated anion-exchange resin (anionite). The disadvantages of this method include the sorption from solutions (i.e. the flow chart incorporates filtering operations of acidic solutions with very low filtration factor) and the high costs of anion-exchange resin (anionite) to be burnt at the stage of making concentrate of platinum metals.

Another related art method for recovery of gold from ore by sorption according to an inventor's certificate of the USSR # 1790619 (IPC S22 V08 published on 23.01.1993, Bulletin # 3) involves recovery of gold from ore by cyanogenation (cyanidation) and sorption with a porous anion-exchange resin AM-2B (anionite) of the strongly- and weakly basic functional groups, and desorption of gold with an acidified solution of thiourea.

This method provides satisfactory results for the recovery of precious metals from ore pulps by their cyanogenation (cyanidation), but has the following disadvantages:
High consumption of reactants (reagents) for the regeneration of saturated anion-exchange resin (anionite) from cyanide media;
Multistep and prolonged (200-300 hours) process of the regeneration of anion-exchange resin (anionite), because first it is to be converted from the alkali-cyanide form to chloride-thiourea, and then back to alkaline cyanide.

### BRIEF DESCRIPTION OF THE INVENTION

The proposed invention solves the problem of bulk recovery of precious metals from hydrochloric acid pulps with high rates; it helps to reduce the duration of sorbent regeneration by 12-13 times, and to decrease the consumption of chemical reagents.

To achieve the specified technical results, the method for sorption recovery of precious metals from minerals containing chlorides of alkali and alkaline-earth metals involves sorption of precious metals from the pulp with the use of synthetic sorbent and subsequent desorption and washing the sorbent which is carried out in 2 stages: at the first stage the sorbent is washed with liquid waste pulp, while at the second stage it is washed with water, and desorption of precious metals is performed with the use of hydrochloric acid solution of thiourea; then precious metals are precipitated from thiourea solution into bulk concentrate with the use of ammonium hydroxide solution; in this case, desorption of precious metals is performed at a temperature of 50-60° C. with solution containing 60-80 g/dm³ of thiourea and 3.10 g/dm³ of hydrochloric acid, and precipitation of precious metals is carried out with the use of ammonium hydroxide at pH=8,7-8,8 and temperature of 50-60° C., and the process is carried out with the use sorbent containing strongly and weakly basic functional groups.

Thanks to these features, the inventive method makes it possible to carry out the regeneration of a commercially produced anion-exchange resin (for example, AM-2B) in combination with a subsequent technologically simple and effective method for production of the bulk concentrate of precious metals from the commercial regenerate.

### DETAIL DESCRIPTION OF PREFERRED EMBODIMENTS OF THE INVENTION

While the invention may be susceptible to embodiment in different forms, it will be described in detail herein, specific embodiments of the present invention, with the understanding that the present disclosure is to be considered an exemplification of the principles of the invention, and is not intended to limit the invention to that as illustrated and described herein.

In a preferred embodiment, the inventive method is implemented as follows: after the roasting of concentrate obtained from the clay and salt wastes of potash production, the thus obtained cinder is leached with a diluted solution of hydrochloric acid (100 g/dm³). The pulp resulted from the leaching and containing 60-70 g/dm³ of HCl and 5-22 g/dm³ of FeCl₃ is used to for sorption of precious metals in a cascade (series) of mesh-drainage devices. For this purpose, AM-2B anion-exchange resin (anionite) is used as an adsorbent, which anionite contains 17% and 83% of tertiary and quaternary amino groups, respectively, which is commercially used for gold recovery. Sorption is carried out under the following conditions: the amount of pulp in each device is ˜100 dm³, the loaded amount of sorbent is 0.5 dm³, and the time of sorption is 1,5-2 hours at each of 6 stages.

When the sorbent is washed off with water, precious metals can be partially desorbed therefrom and thusly lost with the wash water. In order to prevent a possible desorption of precious metals from the saturated sorbent being washed with water after the sorption, the following measures are taken. First, the saturated sorbent is washed off from the sludge (slurry) with the waste liquid pulp, and then with water, and thereafter is regenerated with hydrochloric acid solution of thiourea for 15-24 hours. The bulk concentrate of precious metals is precipitated from the commercial regenerate for 2 hours.

Example 1: Tests to determine the effect of wash water on the content of precious metals in the bulk concentrate were conducted, their results are placed in Table 1.

TABLE 1
Effect of Water Washing of Saturated Anion-Exchange Resin (Anionite) on the Content
of Precious Metals in Bulk Concentrate after Washing with Waste Liquid Pulp

| | Water | | | | | | Amount in wash | |
|---|---|---|---|---|---|---|---|---|
| | consumption, | Content in concentrate, g/ton | | | | | water, % | |
| No | dm³/dm³ | Pd | Au | Pt | Ag | Σ | Fe | Al |
| | 0 | 216 | 8.3 | 4.2 | 29.5 | 258 | — | — |
| 1 | 3.0 | 3740 | 96.5 | 50.0 | 413 | 4300 | 80.1 | 80.0 |
| | 6.0 | 3800 | 103 | 53.0 | 420 | 4370 | 94.1 | 82.0 |
| 2 | 0 | 421 | 15.1 | 5.0 | 271 | 712 | — | — |
| | 2.1 | 16300 | 800 | 127 | 5200 | 22400 | 85.0 | 93.0 |
| 3 | 0 | 373 | 86.0 | 441 | 441 | 944 | — | — |
| | 3.0 | 1370 | 175 | 147 | 147 | 1830 | 91.3 | 91.0 |

It is evident from Table 1 that water washing of the saturated sorbent immediately after its washing with the waste liquid pulp makes it possible to remove more that 80% of iron and aluminum (the average value for 10 experiments is 84% of iron, because of which the content of precious metals in the bulk concentrate increases steeply.

Example 2: Tests were conducted to determine the effect of thiourea's concentration on the recovered amount of precious metals in the desorbate and their results are placed in Table 2.

TABLE 2
Effect of the thiourea concentration on the recovered amount
of in desorbat Temperature is 40° C.

| | Recovered amount, % | | |
|---|---|---|---|
| Concentration, g/dm³ | Pd | Au | Pt |
| 80 | 92 | 100 | 70 |
| 60 | 84 | 98 | 65 |
| 30 | 79 | 93 | — |
| 8 | 43 | — | 60 |

The test has showed that desorption of palladium is highly dependent on the concentration of thiourea in the desorbate (Table 2).

Example 3: Tests to assess the effect of temperature on the intensity of desorption of precious metals were conducted and their results are placed in Table 3.

TABLE 3
Effect of Desorption Temperature on the Recovery of Precious Metals
Theiourea Concentration is 80 g/dm³

| | Desorption degree, | | |
|---|---|---|---|
| | 5, at * amount of | | |
| | solution 10 ppm of | | |
| | anion-exchange resin | | |
| Temperature, ° C. | Pd | Au | Pt |
| 20 | 80 | — | — |
| 40 | 92 | 100 | 70 |
| 50 | 100 | — | — |
| 60 | 100 | — | — |

* Ten (10) volumes of solution per one (1) of volume of anion-exchange resin (anionite)

It is clear from the table that for the optimum temperature range for recovery of palladium is 50-60° C. To recover gold and platinum, the optimum temperature is 40° C., with a slight decrease in the yield of palladium.

Example 4: Tests were conducted to assess the effect of pH on the process of precipitation of palladium, gold and platinum when ammonium hydroxide as precipitator and their results are placed in Table 4.

TABLE 4
Effect of pH on Precipitation of Precious Metals with
Ammonium Hydroxide

| | Amount in bulk concentrate, % | | | |
|---|---|---|---|---|
| pH | Pd | Au | Pt | Ag |
| 6.0 | 57.9 | Not determined | Not determined | 14.4 |
| 7.6 | 75.1 | Not determined | Not determined | 37.2 |
| 8.6 | 98.9 | 99.5 | 91.2 | 58.1 |
| 8.7 | 99.6 | Not determined | Not determined | 88.8 |
| 8.7 | 99.6 | 99.3 | 99.0 | 88.8 |
| 8.7 | 99.3 | 97.1 | 94.2 | 7.5 |
| 8.7 | 96.4 | 91.6 | Not determined | 39.0 |
| 8.8 | 98.8 | 99.7 | 71.3 | 28.3 |
| 8.9 | 96.8 | 100 | 53.5 | 81.9 |
| 9.1 | 95.9 | 98.8 | 63.8 | Not determined |
| 9.4 | 88.0 | Not determined | Not determined | Not determined |

It is obvious from the table that the optimum pH for precipitation of palladium, gold and platinum is 8.7-8.9.

Technical efficiency of the proposed method for recovery of precious metals from minerals containing chlorides of alkali and alkaline earth elements is that it:
provides a means for bulk recovery of precious metals from hydrochloric acid pulps with high rates;
reduces the duration of sorbent regeneration by 12-13 times as compared to the prior art methods;
reduces consumption of chemical reagents;
provides favorable conditions for further processing of bulk concentrates to individual metals (salts).

1. A method for sorption recovery of precious metals from minerals containing alkali and alkaline earth which involves sorption of precious metals from pulp with the use of synthetic sorbent containing strongly and weakly basic functional groups and subsequent desorption and washing of the sorbent which is performed in 2 stages: at the first stage the sorbent is washed with liquid waste pulp, while at the second stage it is washed with water, and desorption of precious metals performed with the use of hydrochloric acid solution of thiourea; followed by precipitation of precious metals from thiourea solution into bulk concentrate with the use of ammonium hydroxide solution.

2. A method as recited in claim 1, wherein the process is carried out the cascade (series) of 6 mesh-drainage units at fixed volume of sorbent charged in each unit.

3. A method as recited in claim 1, wherein desorption of precious metals is carried out with solution containing 60-80 g/dm³ of thiourea and 3-10 g/dm³ of hydrochloric acid at a temperature of 50-60° C.

4. A method as recited in claim 1, wherein precipitation of precious metals is performed with the use of ammonium hydroxide solution at pH=8.7-8.8 and temperature of 50-60° C.
